(19) United States
(12) Patent Application Publication
(10) Pub. No.: US 2010/0002848 A1
(43) Pub. Date: Jan. 7, 2010

(54) TELEPHONE FOR THE VISUALLY IMPAIRED

(75) Inventor: CHEN-YUAN LIU, Taichung (TW)

Correspondence Address: WPAT, PC;INTELLECTUAL PROPERTY ATTORNEYS, 7225 BEVERLY ST., ANNANDALE, VA, 22003, US

(73) Assignee: Hsiuping Institute of Technology, Taichung County (TW)

(21) Appl. No.: 12/166,466

(22) Filed: Jul. 2, 2008

(51) Int. Cl. H04M 11/00

(52) U.S. Cl. 379/52; 379/446

(57) ABSTRACT

A telephone for the visually impaired is disclosed, which comprises a frame and a receiver. The frame is configured with an operation panel and a receiver holder, whereas there are a keypad being disposed at a position on top of the operation panel and a first protruding dot being disposed at a position beneath the operation panel. Moreover, the receiver holder is an open structure that is formed extruding from a side of the frame and is configured with a pressing part. With the aforesaid devices, any visually impaired person is able to place the receiver on the receiver holder in a trouble-free manner while enabling the pressing part to be compressed exactly by the receiver; and he/she is able to recognize the exact location of the keypad for placing a dial as soon as the first protruding dot is felt by the hand of the visually impaired person.

### FIELD OF THE INVENTION

The present invention relates to a telephone for the visually impaired, and more particularly, to a telephone configured with a structure for guiding its receiver to be placed properly and having a keypad with set points for facilitating the visually impaired person to locate the keypad by the tactile sense of his/her palms.

### BACKGROUND OF THE INVENTION

Nowadays, it is becoming an instinct for any one of us to use communication devices for establishing communication with other people. The most familiar example of a communication device is the common telephone. Even for those visually impaired, telephone is still the communication device of choice since it is primarily an audio signal transmitting device.

For helping the visually impaired to recognize the keypad arrangement on those conventional telephones, it is common to arrange a protruding dot at the center of the keypad, i.e. at the key of number 5 on the keypad, that is to be used as a set point that can be felt by the visually impaired and thus locate the positions of other numeric keys on the keypad. Moreover, some telephones try to assist the blind by connecting each numeric key on their keypads to an audio effect controller so that different numeric keys when pressed will respond with different sounds for helping their visually impaired users to recognize whether or not he/she is pressing on the right key by hearing.

Nevertheless, as most keypads only occupy a very small portion of the operation panel of any conventional telephone, it is difficult and time-consuming for the visually impaired to find the set point, which can be very small, among those numeric keys and function keys on such a small keypad.

In addition, users of those conventional telephone will have to put the microphone/receiver unit exactly on the receiver holder in a face-to-face manner while enabling microphone and the receiver of the microphone/receiver unit to be inset into the two sunken recesses correspondingly so that the microphone/receiver unit can press on a pressing part formed in one of the two sunken recesses by its own weight so as to hang up a communication. If a microphone/receiver unit is not being placed on the receiver holder exactly and pressing on the pressing part, the communication will not be terminated for enabling the telephone to receive another call which may sometime cause regret when there is an emergency.

Therefore, it is in need of a telephone for the visually impaired that is configured with a structure for guiding its receiver to be placed properly and having a keypad with set points for facilitating the visually impaired person to locate the keypad easily by the tactile sense of his/her palms.

### SUMMARY OF THE INVENTION

In view of the disadvantages of prior art, the object of the present invention is to provide a telephone for the visually impaired, which is configured with protruding dots to be used as set points that can be easily located as they are designed to be arranged at positions with the consideration for matching those with the size of a human palm, and is structured with an open structure to be used as receiver holder for guiding its receiver to be placed properly and thus hang up the telephone.

To achieve the above object, the present invention provides a telephone for the visually impaired, which comprises: a frame, having an operation panel and a receiver holder; and a receiver, designed to be placed on the receiver holder and being connected to the frame by a cable; wherein there are a keypad being disposed at a position on top of the operation panel and a first protruding dot being disposed at a position beneath the operation panel on a line extending along the center line of the keypad, thereby, any visually impaired person is able to come into contact with and thus recognize the keypad for placing a dial as soon as the first protruding dot is felt by the hand of the visually impaired person.

In an exemplary embodiment of the invention, the receiver holder is an open structure that is formed extruding from a side of the frame and is configured with a bulging fringe at side of the open structure away from the frame and a transverse-disposed bar-like pressing part. Moreover, there is a guiding member being formed on the receiver that is opened on a side thereof and being designed to match with the pressing part of the receiver holder, by which any visually impaired person is able to place the receiver on the receiver holder in a trouble-free manner while using the guiding member to fixedly hold the receiver.

Preferably, the operation panel further comprises a second protruding dot, being arranged at a position between the keypad and the first protruding dot and close to the joint of the operation panel and the receiver holder that is used as a set point specifically for the thumb to recognize for dialing.

Preferably, the operation panel further comprises a third protruding dot, being arranged at a position on top of the keypad and on the exact center extending line as that of the first protruding dot that is used a set point specifically for the middle finger to recognize and thus sliding therefrom all the way down following the center line for locating the first protruding dot or simply functioning as the first protruding when the telephone is operating by a person with large palm.

Preferably, the keypad is arranged at a sunken area on the frame other than the operation panel for enabling a visually impaired person to recognize the keypad simply by touching and sweeping through the surface of the telephone.

Preferably, the keypad comprises a numeric key area and a function key area, wherein there are protruding dots configured on the operation panel at positions close to the function key area that are specifically designed in correspondence to the function key area to be as set points for enabling the visually impaired to recognize the function keys in the function key area.

With the aforesaid structures in the telephone, any visually impaired person is able to place the receiver on the receiver holder in a trouble-free manner while enabling the pressing part to be compressed exactly by the receiver; and he/she is able to recognize the exact location of the keypad for placing a dial as soon as the first protruding dot is felt by the hand of the visually impaired person.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a telephone of the present invention as its receiver is being picked up.

FIG. 2 shows a telephone of the present invention as its receiver is being hung up.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

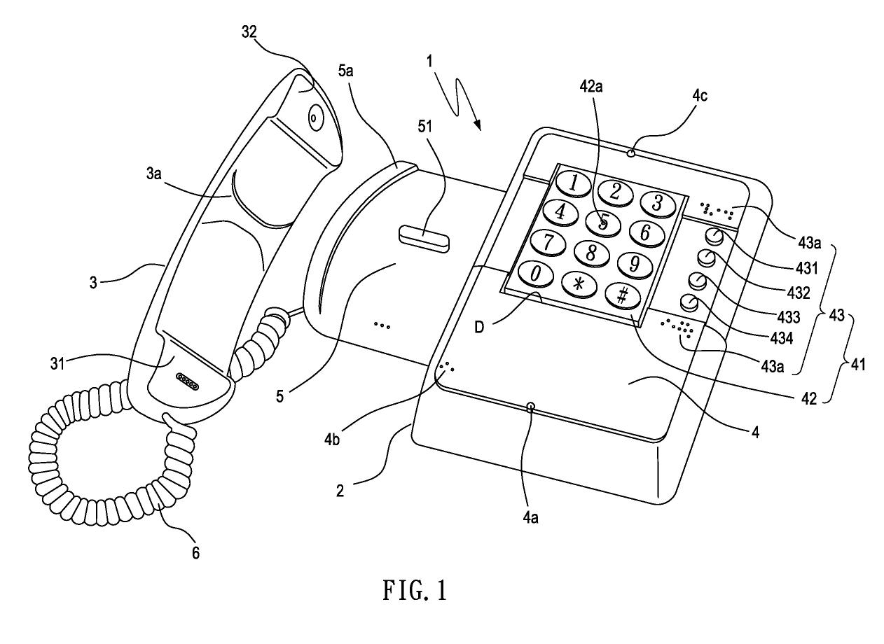

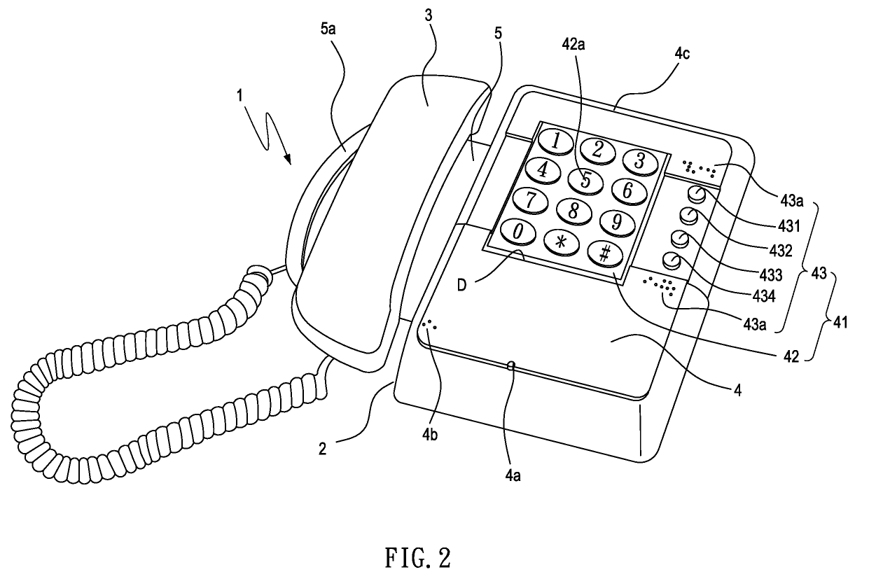

Please refer to FIG. 1 and FIG. 2, which show a telephone of the present invention. In this exemplary embodiment, the telephone for the visually impaired 1 comprises: a frame 2 and a receiver 3.

The frame 2 is configured with an operation panel 4 and a receiver holder 5, in which there is a keypad 41 being disposed at a position on top of the operation panel 4. The keypad 41 includes a numeric key area 42 and a function key area 43, wherein the numeric key area 42 is configured with a plurality numeric keys which are arranged in a matrix listed from the left to the right and the top to the bottom as following: “1, 2, 3”, “4, 5, 6” and “*, 0, #”; and the function key area 43 is also configured with a plurality of function keys, which includes a re-dial key 431, a transfer key 432, a hold key 433 and a set key 434, and so on. It is noted that the function keys to be configured in the function key area 43 are determined as actual required, and thus are not limited by those shown in FIG. 1.

As shown in FIG. 1 and FIG. 2, there is a protruding dot 42a being formed at the key of number 5 on the numeric key are 42 which is to be used as a set point 42a similar to those in the conventional telephones. Moreover, there is a first protruding dot 4a being disposed at a position beneath the operation panel 4 on a line extending along the center line the same as that of the set point 42a, by that when such first protruding dot 4 is felt by the palm of a visually impaired person, the middle finger of such palm will be positioned just right on the set point 42a and thus the locations of all the numeric keys on the keypad are recognized by the visually impaired person

In addition, there are another protruding dots 43a being arranged on the operation panel 4 at a position near the function key area 43, which is used as an instruction for informing the visually impaired person with the functionalities of the plural function keys.

Moreover, the operation panel 4 is further configured with a second protruding dot 4b and a third protruding dot 4c, in which the second protruding dot 4b is arranged at a position between the keypad 41 and the first protruding dot 4a and close to the joint of the operation panel 4 and the receiver holder 5; and the third protruding dot 4c is arranged at a position on top of the keypad 41 and on the exact center extending line as that of the first protruding dot 42a. Thereby, when the palm of a visually impaired person is in touch with the first protruding dot 4a, his/her thumb will be placed at a location right on the second protruding dot 4b and the same time his/her middle finger will be placed at a location right on the set point 42a. However, if the visually impaired person has a comparatively larger palm or longer fingers, his/her middle finger will touch the third protruding dot 4c instead of the set point 42a so that he/she will be able to locate the set point 42a by the whereabouts of the two protruding dot 4b, 4c. That is, by recognizing the whereabouts of the first, the second and the third protruding dots 4a, 4b, 4c, the visually impaired person will be able to find the set point 42a and thus is enabled to place a dial.

As shown in FIG. 1 and FIG. 2, the keypad 41 is arranged at a sunken area on the operation panel 4 for setting the keypad 41 apart from other than areas of the operation panel 4 by a drop D and thus enabling a visually impaired person to recognize the keypad 41 simply by touching and sweeping through the surface of the telephone 1 and further find the set point 42 for performing a dial.

The receiver 3, being adapted to be placed on the receiver holder 5, is configured with a microphone unit 31 and a receiving unit 32 in a manner that the distance between the microphone unit 31 and the receiving unit 32 is about equal to the length of the receiver holder 5. Moreover, the receiver 3 is connected to the frame by a cable; and the receiver holder 5 is a structure that is formed extruding from a side of the frame 2 and is configured with a bulging fringe 5a at side of the structure away from the frame 2 and a transverse-disposed bar-like pressing part 51. Moreover, there is a guiding member 3a being formed on the receiver 3 that is opened on a side thereof and being designed to match with the pressing part 51 of the receiver holder 5

Thus, when a visually impaired person intends to hang up a phone, he/she can easily place the receiver 3 on the receiver holder 5 from a side or the top of the receiver holder 5 since the receiver holder 5 is substantially an open structure extruding from a side of the frame 2. Furthermore, by the restriction of the bulging fringe 5a, the receiver is confined to a position where it can press exactly on the pressing part 51 for terminating the communication. In addition, by the guidance of the guiding member 3a, the receiver 3 is guided to the position where it can press exactly on the pressing part 51.

To sum up, the present invention provides a telephone for the visually impaired which is configured with protruding dots to be used for assisting a visually impaired person to locate a set point, i.e. at the key of number 5 on the keypad, by the tactile sense of his/her palm and fingers so as to perform a dial. Moreover, by designing the receiver holder 5 as an open structured device having a bulging fringe formed thereon for holding the receiver at a specific position capable of pressing exactly on the pressing part, any visually impaired person is able to place the receiver 3 on the receiver holder 5 in a trouble-free manner for terminating a communication.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A telephone for the visually impaired, comprising:
a frame, configured with an operation panel and a receiver holder; and
a receiver, adapted to be placed on the receiver holder and being configured with a microphone unit and a receiving unit in a manner that the distance between the microphone unit and the receiving unit is about equal to the length of the receiver holder;
wherein, the receiver is connected to the frame by a cable; and there are a keypad being disposed at a position on top of the operation panel and a first protruding dot being disposed at a position beneath the operation panel on a line extending along the center line of the keypad; and the receiver holder is a structure that is formed extruding from a side of the frame and is configured with a transverse-disposed bar-like pressing part; thereby, any visually impaired person is able to recognize the location of the keypad as soon as the first protruding dot is felt by the hand of the visually impaired person, and any visually impaired person is able to place the receiver on the receiver holder in a trouble-free manner as it is protruding out of the frame.

2. The telephone of claim 1, wherein the receiver holder is configured with a bulging fringe at side of the same away from the frame so as to be used for fixedly holding the receiver

3. The telephone of claim 1, wherein there is a guiding member being formed on the receiver that is opened on the two sides thereof and being designed to match with the pressing part of the receiver holder, for holding and fixing the receiver.

4. The telephone of claim 1, wherein the operation panel further comprises a second protruding dot, being arranged at a position between the keypad and the first protruding dot and close to the joint of the operation panel and the receiver holder that is used as a set point specifically for the thumb to recognize for dialing.

5. The telephone of claim 4, wherein the operation panel further comprises a third protruding dot, being arranged at a position on top of the keypad and one the exact center extending line as that of the first protruding dot which is used a set point specifically for the middle finger to recognize and thus sliding therefrom all the way down following the center line for locating the first protruding dot or simply functioning as the first protruding when the telephone is operating by a person with large palm.

6. The telephone of claim 1, wherein the keypad is arranged at a sunken area on the operation panel for setting the keypad apart from other than areas of the operation panel and thus enabling a visually impaired person to recognize the keypad simply by touching and sweeping through the surface of the telephone.

7. The telephone of claim 1, wherein the keypad further comprises a numeric key area and a function key area.

8. The telephone of claim 7, wherein there are protruding dots being configured on the operation panel at positions close to the function key area that are specifically designed in correspondence to the function key area to be as set points for enabling the visually impaired to recognize the function keys in the function key area
